(19) United States
(12) Patent Application Publication
(10) Pub. No.: US 2006/0245745 A1
(43) Pub. Date: Nov. 2, 2006

(54) Photography appliance and method for its use

(76) Inventor: Jeffrey Mazon, San Diego, CA (US)

Correspondence Address: Law Office of Kenneth P. Krohn, Post Office Box 4415, Carlsbad, CA, 92018, US

(21) Appl. No.: 11/120,096

(22) Filed: May 2, 2005

(51) Int. Cl. G03B 15/00

(52) U.S. Cl. 396/5

(57) ABSTRACT

The present invention is generally comprised of an appliance that may be of assistance in photographing of an object and a method for using the appliance, wherein the appliance provides a means for photographing the object without the appearance of a background in the photograph of the object. In some embodiments, the appliance is generally comprised of a protective housing, a reflective backdrop, and backdrop attachment means to removably or permanently attach the reflective backdrop to the protective housing. The protective housing generally encloses the reflective backdrop, which preferably has a surface possessing retroreflective or diffuse-reflective properties. In other embodiments, the appliance is generally comprised of a supporting member, a retroreflective backdrop, and backdrop attachment means to attach the retroreflective backdrop to the supporting member.

### BACKGROUND

The present invention generally relates to an appliance that may be of assistance in photographing an object and a method for using the appliance. More specifically, the present invention generally relates to an appliance that may assist in the photography of an object and a method for using the appliance, wherein the appliance has a reflective backdrop that provides a means for photographing the object without the appearance of a background in the photograph of the object. Generally, a photograph of the object without the appearance of a background, as referenced herein, is a photograph in which the background is essentially blank (except for a homogeneous color or combination of colors) so that there are no discernable features in the photograph of the object other than the object itself.

There currently exist in the relevant art devices that may be used to provide a background for photographs of persons and objects. Typically, these devices include a stage or frame that supports a screen or other type of material that provides a background for the resulting photograph. Some of these devices are large and difficult to move from one location to another. Many photographic stages fall into this category. It is often desirable, however, to have a device that can be easily transported so that objects can be photographed in a remote location. For example, in nature photography, it may be desirable to have a device that can be used in a wilderness area to photograph flowers and insects. Although there are some devices available that have a degree of portability, these devices tend to suffer from several disadvantages. For example, the devices may have some portability, but have features that render portability somewhat ineffective. For example, some “portable” devices are comprised of a multitude of component parts beyond the frame and screen, such as lighting fixtures and cords, object positioning equipment, and other features. These types of devices may be difficult or cumbersome to use because they are comprised of many parts that require assembly prior to use and disassembly after use. In addition, they may be relatively expensive because they are comprised of a multitude of parts. Similarly, they may be relatively expensive to maintain because parts, such as light bulbs, may be broken or otherwise cease to function. Some of the many parts comprising the device may also become lost or may be misplaced. In other cases, devices having some degree of portability may have fewer parts, but are still cumbersome to use because they must still be assembled prior to use and disassembled after use. In many of these cases, the device may not include a convenient way to assemble the parts in a self-contained package for transport. Once again, this may give rise to lost or misplaced parts. In all of these “portable” devices, there may not be a suitable means for protecting the photographic background screen that comprises the device during the transport of the device. In these cases, the background screen may become damaged, necessitating the replacement or repair of the screen. In still other cases, the device may not provide for means to photograph the object in a manner so that the object appears in the photograph without any background. For example, the background may have features of its own that show up in the resulting photograph. In contrast, in many areas of photography, such as in product photography, it is often desirable to have a photograph of an object that does not have a background that detracts from the object. If the photograph of the object appears without a background (other than one of a homogeneous color), the photograph may be placed in advertising media, such as a brochure or web page, having the same background color so that the product does not appear to have any background. This type of format is desirable because there is nothing to draw the viewer's attention away from the object. Thus, there is a need for an appliance that may be used to photograph an object in a manner so that the object appears in the photograph without a background (except for a homogeneous color). There is also a need for the appliance to be portable and to be constructed in a manner so that the photographic backdrop of the appliance is protected from damage. In addition, there is a need for the appliance to be lightweight and simple to use. There is also a need for the appliance to be comprised of relatively few parts, without the requirement for assembly and disassembly. Further, there is a need for the appliance to be relatively inexpensive to produce and maintain. Finally, there is a need for the appliance to be easy to transport from one location to another where it can be used without ancillary equipment or utilities, such as electric power.

In yet other cases, it may be necessary to photograph an object or person in a manner so that the object or person appears in the photograph without any background, but the object or person may be too large to be photographed on a portable device. In these cases, it is desirable for the device to have the features related to photographing an object without a background, as described above, but without the portability features described above. Thus, there is also a need for an appliance that may be used to photograph an object or person in a manner so that the object or person appears in the photograph without a background (except for a homogeneous color), wherein the appliance is not necessarily portable.

### SUMMARY

The present invention is directed to an appliance that may assist in photographing an object and a method for using the appliance, wherein the appliance has a reflective backdrop that provides a means for photographing the object without the appearance of a background in the photograph of the object, all in a manner that meets the needs discussed above in the Background section. As described in greater detail below, the present invention, when used for its intended purposes, has many advantages over other devices known in the art, as well as novel features that result in a new object photography appliance and methods for its use that are not anticipated, rendered obvious, suggested, or even implied by any prior art means, devices or methods, either alone or in any combination thereof.

One embodiment of the present invention generally discloses an appliance for assisting in the photography of an object. In this embodiment, the appliance is generally comprised of a protective housing, a reflective backdrop, and backdrop attachment means for attaching the reflective backdrop to the protective housing. The protective housing is further comprised of a top member, a bottom member, and housing connecting means for pivotally connecting the top member to the bottom member. In this embodiment, the reflective backdrop provides a means for photographing the object without the appearance of a background in the photograph of the object. In other embodiments, the reflective backdrop is further comprised of a bottom portion, a top portion, and an arcuate portion disposed between the bottom portion and the top portion. In these embodiments, the bottom portion of the reflective backdrop is positioned approximately adjacent to the bottom member, the top portion of the reflective backdrop is positioned approximately adjacent to the top member, and the arcuate portion of the reflective backdrop is positioned approximately adjacent to the housing connecting means. In some of these embodiments, the bottom member and the top member of the protective housing are positioned approximately adjacent to one another so that the protective housing is in a “closed” position, and the arcuate portion of the reflective backdrop retains its curved shape while the protective housing is in the closed position. In other embodiments, the reflective backdrop has approximately the same shape as the protective housing.

In other embodiments of the present invention, the appliance is generally comprised of a protective housing, a reflective backdrop, and backdrop attachment means for attaching the reflective backdrop to the protective housing. The protective housing is further comprised of a top member, a bottom member, and housing connecting means for pivotally connecting the top member to the bottom member, wherein the top member of the protective housing is further comprised of a top joining portion and a lid portion, and the bottom member of the protective housing is further comprised of a bottom joining portion and a base portion. In these embodiments, the reflective backdrop provides a means for photographing the object without the appearance of a background in the photograph of the object. In some of these embodiments, the reflective backdrop is further comprised of a bottom portion, a top portion, and an arcuate portion disposed between the bottom portion and the top portion. In addition, the bottom portion of the reflective backdrop is positioned approximately adjacent to the bottom member, the top portion of the reflective backdrop is positioned approximately adjacent to the top member, and the arcuate portion of the reflective backdrop is positioned approximately adjacent to the housing connecting means. The end of the top portion of the reflective backdrop that is distal from the arcuate portion is attached approximately to the end of the lid portion of the top member that is distal from the top joining portion by the backdrop attachment means. The end of the bottom portion of the reflective backdrop that is distal from the arcuate portion is attached approximately to the end of the base portion of the top member that is distal from the bottom joining portion by the backdrop attachment means. In some of these embodiments, the arcuate portion of the reflective backdrop retains its curved shape while the base portion of the bottom member and the lid portion of the top member of the protective housing are positioned approximately adjacent to one another so that the protective housing is in a “closed” position. In other embodiments, the backdrop attachment means is comprised of means to removably attach the reflective backdrop to the protective housing, such as hook and loop fasteners, clamps, or any combination of the same. In yet other embodiments, the backdrop attachment means is comprised of means to permanently attach the reflective backdrop to the protective housing, such as an adhesive. In some embodiments, the bottom portion, the top portion, and the arcuate portion of the reflective backdrop are each comprised of a support medium and a reflective layer disposed on the surface of the support medium. In some of these embodiments, the support medium may be comprised of a semi-flexible material, such as polycarbonate. In some embodiments, the reflective layer may be comprised of a retroreflective material. In other embodiments, the reflective layer may be white, silver, or black in color. In still other embodiments, the protective housing may be approximately rectangular or square in shape. In some of these embodiments, the protective housing may have a length in the range between approximately 3 feet and 1.5 feet, a width in the range between approximately 2 feet and 1.2 feet, and a thickness in the range from one inch to six inches. In some embodiments of the present invention, the protective housing may be further comprised of at least one bracing member, wherein one end of the at least one bracing member is pivotally attached to the top member, and the other end of the at least one bracing member is pivotally attached to the bottom member. In some of these embodiments, the protective housing is in an approximately “open” position when the appliance is positioned for photographing the object, and the at least one bracing member positions the angle between the top member and the bottom member while the protective housing is in the open position to an angle in the range from 45 degrees to 180 degrees.

In other embodiments of the present invention, the appliance is generally comprised of a protective housing, a reflective backdrop that serves as the background for purposes of photographing the object, and backdrop attachment means for attaching the reflective backdrop to the protective housing. In these embodiments, the protective housing is further comprised of a top member, a bottom member, and housing connecting means for pivotally connecting the top member to the bottom member. In addition, the reflective backdrop is further comprised of a bottom portion, a top portion, and an arcuate portion disposed between the bottom portion and the top portion. In these embodiments, the bottom portion of the reflective backdrop is positioned approximately adjacent to the bottom member, the top portion of the reflective backdrop is positioned approximately adjacent to the top member, and the arcuate portion of the reflective backdrop is positioned approximately adjacent to the housing connecting means. In addition, the protective housing is in a “closed” position when the bottom member and the top member of the protective housing are positioned approximately adjacent to one another, and the arcuate portion of the reflective backdrop retains its curved shape while the protective housing is in the closed position. In some of these embodiments, the housing connecting means is comprised of a hinge. In other embodiments, the protective housing is further comprised of closure means for holding the top member adjacent to the bottom member when the protective housing is in the closed position. In still other embodiments, the protective housing is further comprised of at least one handle and handle attachment means for operably attaching the at least one handle to the top member or the bottom member of the protective housing. In other embodiments, the reflective backdrop does not have the same approximate shape as the protective housing.

In other embodiments of the present invention, the appliance is generally comprised of a protective housing, at least two reflective backdrops, and backdrop attachment means for attaching the at least two reflective backdrops to the protective housing or to another of the at least two reflective backdrops. In these embodiments, the protective housing is further comprised of a top member, a bottom member, and housing connecting means for pivotally connecting the top member to the bottom member, wherein the top member of the protective housing is further comprised of a top joining portion and a lid portion, and the bottom member of the protective housing is further comprised of a bottom joining portion and a base portion. In addition, the reflective backdrop is further comprised of a bottom portion, a top portion, and an arcuate portion disposed between the bottom portion and the top portion, wherein the reflective backdrop is disposed within the perimeter of the protective housing. In these embodiments, the at least two reflective backdrops provide a means for photographing the object without the appearance of a background in the photograph of the object, and the arcuate portion of the at least two reflective backdrops retain their curved shape while the base portion of the bottom member and the lid portion of the top member of the protective housing are positioned approximately adjacent to one another so that the protective housing is in a “closed” position. In some of these embodiments, the bottom portion of the first of the at least two reflective backdrops is positioned approximately adjacent to the bottom member, the top portion of the first of the at least two reflective backdrops is positioned approximately adjacent to the top member, and the arcuate portion of the first of the at least two reflective backdrops is positioned approximately adjacent to the housing connecting means. In these embodiments, the bottom portion of each additional at least two reflective backdrops is positioned approximately adjacent to the bottom portion of the prior at least two reflective backdrops, the top portion of each additional at least two reflective backdrops is positioned approximately adjacent to the top portion of the prior at least two reflective backdrops, and the arcuate portion of each additional at least two reflective backdrops is positioned approximately adjacent to the arcuate portion of the prior at least two reflective backdrops. In other embodiments, the bottom portion of the at least two reflective backdrops is positioned approximately adjacent to a portion of the bottom member, the top portion of the at least two reflective backdrops is positioned approximately adjacent to a portion of the top member, and the arcuate portion of the at least two reflective backdrops is positioned approximately adjacent to a portion of the housing connecting means, wherein the at least two reflective backdrops are positioned in the protective housing in a side-by-side manner.

In other embodiments of the present invention, a method of photographing an object is disclosed wherein the object appears in the photograph without a background. In one embodiment, the method comprises the following steps. First, an appliance is provided to assist in photographing the object, wherein the appliance may have any of the structures, features, characteristics and operation of any embodiments or combinations of embodiments of the portable appliance of the present invention illustrated and described herein. Second, the top member and the bottom member are positioned so that the protective housing is in the “open” position, wherein the reflective backdrop is positioned so that it is available as a background for photographing the object. Third, the object is placed on or in front of the reflective backdrop in the position desired by the user of the appliance for purposes of photographing the object. Fourth, a photographic device, such as a camera, is provided for purposes of photographing the object. Fifth, the photographic device is positioned in a location so that the object and a portion of the reflective backdrop form the field of view of the photographic device. Sixth, the object is photographed using the photographic device. In other embodiments of the present invention, the method of using the appliance may further comprise the steps of removing the object from the reflective backdrop and positioning the top member and the bottom member in the “closed” position (wherein the top member and the bottom member are positioned approximately adjacent to one another). In yet other embodiments wherein the backdrop attachment means provides for removable attachment of the reflective backdrop to the protective housing, the method of using the appliance may further comprise the steps of removing the reflective backdrop from the protective housing and attaching the same or a different reflective backdrop to the protective housing using the backdrop attachment means. In these embodiments, such steps may be performed after the second step, but before the third step, of the method described above in this paragraph.

In yet other embodiments of the present invention, an appliance for assisting in the photography of an object is disclosed, wherein the appliance is comprised of a supporting member, a retroreflective backdrop, and backdrop attachment means for attaching the retroreflective backdrop to the supporting member. In these embodiments, the retroreflective backdrop provides a means for photographing the object without the appearance of a background in the photograph of the object. In some embodiments, the supporting member is further comprised of a top supporting portion and a bottom supporting portion, and the retroreflective backdrop is further comprised of a bottom portion, a top portion, and an arcuate portion disposed between the bottom portion and the top portion. In these embodiments, a portion of the bottom portion of the retroreflective backdrop is positioned approximately adjacent to a portion of the bottom supporting portion of the supporting member, a portion of the top portion of the retroreflective backdrop is positioned approximately adjacent to a portion of the top supporting portion of the supporting member, and the arcuate portion of the reflective backdrop has an arcuate shape. In some of these embodiments, the backdrop attachment means is comprised of an adhesive. In other embodiments, the bottom portion, the top portion, and the arcuate portion of the retroreflective backdrop are each comprised of a support medium and a retroreflective layer disposed on the surface of the support medium. In some of these embodiments, the support medium is comprised of polycarbonate. In other embodiments, the retroreflective layer may be white, silver, or black in color. The present invention also includes a method of photographing an object using the appliance described in this paragraph, so that the object appears in the photograph without a background. The method comprises the steps of providing the appliance to assist in photographing the object, positioning the object on or in front of the retroreflective backdrop, providing a photographic device (such as a camera) to photograph the object, positioning the photographic device in a location so that the object and a portion of the retroreflective backdrop form the field of view of the photographic device, and photographing the object using the photographic device.

Thus, the present invention meets the needs described above in the Background section. For example, the appliance of the present invention may be used to photograph an object in a manner so that the object appears in the photograph without a background (except for a homogeneous color). In addition, in some embodiments, the appliance is portable and may be constructed in a manner so that the photographic backdrop of the appliance is protected from damage. For example, when the appliance is transported, the reflective backdrop is completely enclosed within the protective housing so that it is protected from the elements. Further, the portable appliance is lightweight and comprised of relatively few parts. There is also no need for the appliance to be assembled prior to use and disassembled after use (with the possible exception of a simple change in reflective backdrop). Thus, the appliance is also simple to use. Further still, the appliance should be relatively inexpensive to produce and maintain. Finally, the appliance may be used in remote locations without the need for ancillary equipment or utilities, such as electric power.

There has thus also been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the accompanying drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is a perspective view of an embodiment of an appliance of the present invention in the “open” position, as viewed from the side of and above the appliance as it would typically be positioned for purposes of photographing an object;

FIG. 2 is an elevation view of the embodiment of the appliance illustrated in FIG. 1, as taken along the lines 2-2 in FIG. 1;

FIG. 3 is an elevation view of the embodiment of the appliance illustrated in FIG. 1 in the “closed” position, except that the embodiment of the appliance of FIG. 3 includes bracing members that are not present in the appliance of FIG. 1;

FIG. 4 is an enlarged cross-sectional view of an embodiment of a reflective backdrop of an appliance comprising the present invention; and

FIG. 5 is a perspective view of another embodiment of an appliance of the present invention, as viewed from the side of and above the appliance as it would typically be positioned for purposes of photographing an object.

### DETAILED DESCRIPTION

Reference will now be made in detail to the preferred embodiments of the present invention, examples of which are illustrated in the accompanying drawings. While the invention will be described in conjunction with the preferred embodiments, it is to be noted that the embodiments are not intended to limit the invention to those embodiments. On the contrary, the invention is intended to cover alternatives, modifications and equivalents, which may be included within the spirit and scope of the invention as defined by the appended claims.

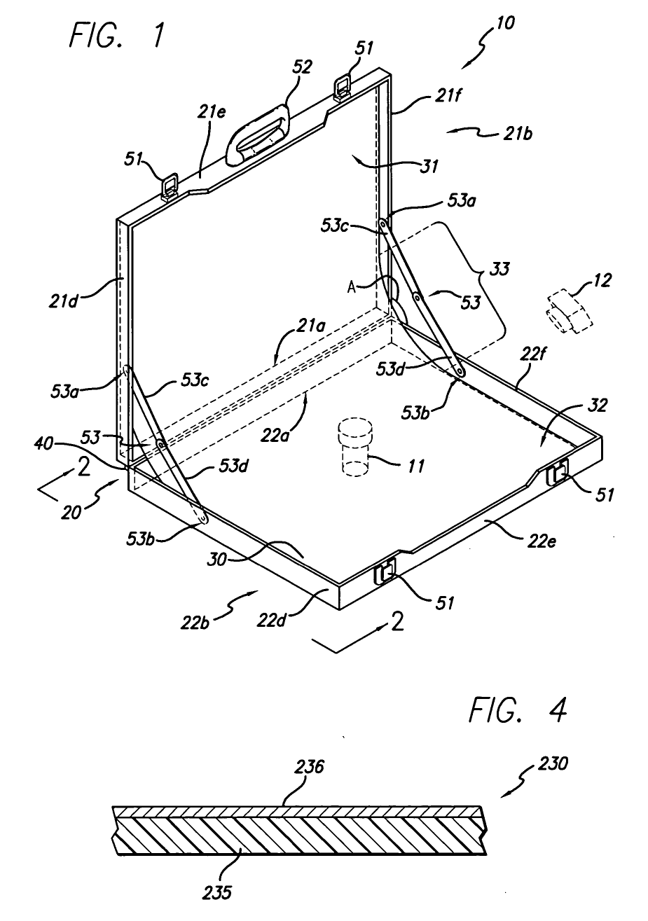

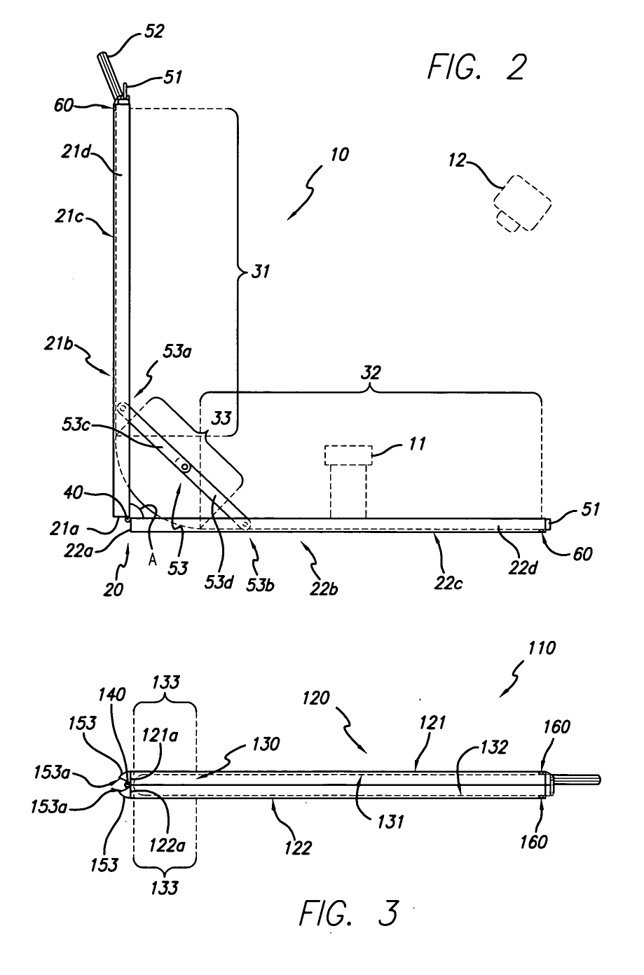

One embodiment of the present invention is illustrated in FIG. 1 and FIG. 2. In this embodiment, the present invention discloses an appliance 10 for assisting in the photography of an object 11, which is not a part of the present invention, using a photographic device, such as a camera 12, which is also not a part of the present invention. In this embodiment, the appliance 10 is comprised of a protective housing 20, a reflective backdrop 30, and backdrop attachment means, which are described in more detail below, for attaching the reflective backdrop 30 to the protective housing 20. The protective housing 20 is further comprised of a top member 21, a bottom member 22, and housing connecting means, which are described in more detail below, for pivotally connecting the top member 21 to the bottom member 22. Generally, the reflective backdrop 30 provides a means for photographing the object 11 without the appearance of a background in the photograph of the object 11, as described in more detail below. In the illustrated embodiment, the top member 21 of the protective housing 20 is further comprised of a top joining portion 21a and a lid portion 21b. The bottom member 22 of the protective housing 20 is further comprised of a bottom joining portion 22a and a base portion 22b. Generally, the top joining portion 21a (or portions thereof) and the bottom joining portion 22a (or portions thereof) are the portions of the protective housing 20 that are adjacent to and connected to the housing connecting means, which are described in more detail below. For example, in the illustrated embodiment, the housing connecting means is a hinge 40 that extends along a portion of the length of the top joining portion 21a and the bottom joining portion 22a, which are portions of the top member 21 and the bottom member 22, respectively. In this embodiment, the hinge 40, as the housing connecting means, allows the top member 21 to pivot (or rotate) relative to the bottom member 22 of the protective housing 20. Thus, the protective housing 20 may be placed in the “open” position by rotating the top member 21 relative to the bottom member 22 so that they are no longer approximately adjacent to one another and instead are positioned so that the reflective backdrop 30 is exposed in a manner so that the object 11 may be photographed. The embodiment of the appliance 10 illustrated in FIG. 1 is portrayed in the open position. On the other hand, when the top member 21 and the bottom member 22 of the protective housing 20 are positioned approximately adjacent to one another, the protective housing 20 is placed in the “closed” position. FIG. 3 illustrates the appliance 10 of FIG. 1 in the closed position, as opposed to the open position. (It is to be noted, however, that the embodiment of the appliance 110 in FIG. 3 is further comprised of bracing members 153, which are described in more detail below, that are not included in appliance 10.) For example, the top member 121 and the bottom member 122 of the protective housing 120 of the appliance 110 illustrated in FIG. 3 have been rotated about the hinge 140 (as housing connecting means in this embodiment) until the top member 121 is approximately adjacent to the bottom member 122. In the appliance 10 illustrated in FIG. 1 and FIG. 2, the reflective backdrop 30 is further comprised of a top portion 31, a bottom portion 32, and an arcuate portion 33 disposed between the bottom portion 32 and the top portion 31. The bottom portion 32 of the reflective backdrop 30 is positioned approximately adjacent to the bottom member 22 of the protective housing 20, while the top portion 31 of the reflective backdrop 30 is positioned approximately adjacent to the top member 21 of the protective housing 20. The arcuate portion 33 of the reflective backdrop 30 is positioned approximately adjacent to the housing connecting means (the hinge 40 in this embodiment), which is described in more detail below. It is to be noted that “approximately adjacent” in this context does not mean that the arcuate portion 33 rests against the surface of the hinge 40, the bottom joining portion 22a, or the top joining portion 21a. Instead, the arcuate portion 33 has a curved surface that is positioned away from these portions of the protective housing 20 in the manner described in more detail below.

In the embodiment of the present invention illustrated in FIG. 1 and FIG. 2, the protective housing 20 is approximately in the shape of a rectangle, when viewed from above the top member 21. In other embodiments, the protective housing 20 may be of almost any shape, as long as the shape allows for the photographing of the object 11 in the manner described in more detail below. For example, the protective housing 20 may have the approximate shape of a circle, ellipse, trapezoid, triangle, parallelogram, polygon, or other shape having curved or line segments or any combination of all such shapes. As illustrated in FIG. 1 and FIG. 2, the preferred shape of the protective housing 20 is square or rectangular. Also in the illustrated embodiment, the lid portion 21b of the protective housing 20 is comprised of a primary surface 21c and side portions 21d, 21e, 21f. Similarly, the base portion 22b of the protective housing 20 is comprised of a primary surface 22c and side portions 22d, 22e, 22f. In the illustrated embodiment, the top joining portion 21a and the side portions 21d, 21e, 21f of the top member 21, as well as the bottom joining portion 22a and the side portions 22d, 22e, 22f of the bottom member 22, are each approximately perpendicular to the primary surfaces 21c and 22c, respectively, and each extends to approximately the same height above the primary surfaces 21c and 22c, respectively. In other embodiments of the present invention, one or more of the top joining portion 21a and the side portions 21d, 21e, 21f of the top member 21, as well as one or more of the bottom joining portion 22a and the side portions 22d, 22e, 22f of the bottom member 22, may not be approximately perpendicular to the primary surfaces 21c and 22c, respectively, and may extend to different heights above the primary surfaces 21c and 22c, respectively. For example, the side member 21e of the top member 21 may have a height above the primary surface 21c that is 50% greater than that illustrated in FIG. 1, and the side member 22e of the bottom member 22 may have a height above the primary surface 21c that is 50% less than that illustrated in FIG. 1, so that the protective housing 20 may still enclose and protect the reflective backdrop 30 within the protective housing 20 when the protective housing 20 is in the closed position. In the various embodiments of the present invention, however, the top joining portion 21a and the side portions 21d, 21e, 21f of the top member 21 and the bottom joining portion 22a and the side portions 22d, 22e, 22f of the bottom member 22 are, in combination, each high enough to protect the reflective backdrop 30 in the manner described in more detail below. In addition, the protective housing 20 is preferably of a size so that it is portable. For example, in various preferred embodiments that typically involve table photography, the protective housing 20 may have dimensions of 3 feet by 2 feet, 2 feet by 1.5 feet, or 1.5 feet by 1.2 feet, so that on an overall basis the preferred dimensions of the protective housing are a length in the range between approximately 3 feet and 1.5 feet and a width in the range between approximately 2 feet and 1.2 feet. In some of these preferred embodiments, the thickness of the protective housing 20, when measured between the primary surface 21c of the top member 21 and the primary surface 22c of the bottom member 22, may be in the range between one inch and six inches. The top member 21 and the bottom member 22 of the protective cover 20 may be constructed from almost any suitable rigid or semi-rigid material or combinations of such materials that are capable of supporting the reflective backdrop 30 in the manner described herein. For example, the top member 21 and the bottom member 22 may be constructed of wood, metal, leather, rigid paper products, and rigid polymer materials, such as polyvinyl chloride or polystyrene, or any combination of all such materials. In other embodiments, the top member 21 and the bottom member 22 may also be comprised in part of non-rigid materials. For example, a top portion 21 constructed of wood may have an outer layer of cloth, leather, paint, polymer (such as polypropylene), or any combination of such materials. Preferably, the top member 21 and the bottom member 22 are constructed of a rigid polymer material, such as polyvinyl chloride.

The housing connecting means, as described above and illustrated in connection with FIG. 1 and FIG. 2, may be a hinge 40 that extends along all or a portion of the top joining portion 21a and the bottom joining portion 22a. In other embodiments, the housing connecting means may be almost any suitable means that allows the top member 21 to pivot relative to the bottom member 22. For example, in other embodiments, the housing connecting means may be bracket/pin combinations, bracket/bolt/washer combinations, cloth, leather, or other pivotal connectors, or any combinations of such pivotal connectors. In the embodiment of the present invention illustrated in FIG. 1 and FIG. 2, the protective housing 20 is also comprised of closure means, which are comprised of two clasps 51 in this embodiment. In other embodiments, there may not be any clasps 51, or there may be any number of clasps 51. In still other embodiments, there may be no closure means or other closure means may be used. For example, the closure means may be comprised of suitable hook and loop fasteners (such as VELCRO), any suitable type of latch, clamp, hasp, lock, buckle, clip, catch, or clasp, any suitable type of detachable connector or fastener, or any combination of any of the foregoing. The preferred closure means (and number of clasps 51 in embodiments utilizing clasps 51) generally depends upon the portability desired for and the anticipated use of the appliance 10. For example, an appliance 10 that may be used in adverse environments, such as wilderness areas, may have a greater number of clasps 51 and use types of clasps 51 having relatively greater strength. In the illustrated embodiment, the protective housing 20 is also further comprised of a handle 52 and handle attachment means, which are described in more detail below, to attach the handle 52 to the top member 21 (as illustrated in FIG. 1 and FIG. 2) or the bottom member 22 of the protective housing 20. Although the protective housing 20 of the illustrated embodiment is comprised of a single handle 52, there may not be any handle 52, or there may be more than one handle 52, in other embodiments. In yet other embodiments, the handle 52 may be almost any type or size of handle 52 suitable to the anticipated use of the appliance 10. The handle attachment means may be any suitable means to attach the handle to the top member 21 or the bottom member 22 of the protective housing 20. For example, the handle attachment means may be comprised of glues, adhesives, adhesive tapes, epoxies, screws, rivets, pins, bolts, clamps, brackets, ties, or any other type of connectors or fasteners or combinations of any of the foregoing. In the illustrated embodiment, the protective housing 20 is also further comprised of two bracing members 53, wherein one end 53a of each bracing member 53 is pivotally attached to the top member 21, and the other end 53b of each bracing member 53 is pivotally attached to the bottom member 22. In other embodiments, the protective housing 20 may be comprised of only one bracing member 53, more than two bracing members 53, or no bracing members 53. In the illustrated embodiment, each bracing member 53 is also further comprised of a top bracing portion 53c and a bottom bracing portion 53d. The top bracing portion 53c and the bottom bracing portion 53d are pivotally connected together at their respective ends that are not connected to the top member 21 or the bottom member 22. Thus, when the protective housing 20 is in its open position, the bracing members 53 hold the top member 21 and the bottom member 22 in a designated position relative to one another. For example, in the illustrated embodiment, the angle A between the top member 21 and the bottom member 22 is approximately 90 degrees. In other embodiments, the angle A may be almost any angle desired in order to photograph the object 11, as described in more detail below. Preferably, the angle A between the top member 21 and the bottom member 22 is in the range of approximately 45 degrees to approximately 180 degrees. More preferably, the angle A between the top member 21 and the bottom member 22 is in the range of 90 degrees to 180 degrees. In this embodiment, the bracing members 53 pivot at the connection between the top bracing portion 53c and the bottom bracing portion 53d, so that the top bracing portion 53c and the bottom bracing portion 53d fold together as the protective housing 20 is closed. In other embodiments, the bracing members 53 may have any suitable structure to accomplish their purpose of positioning the angle A between the top member 21 and the bottom member 21 while the protective housing 20 is in the open position for purposes of photographing the object 11. For example, the bracing members 53 may each be comprised of a single piece that has one end 53a pivotally connected to the top member 21 and a pin disposed in the other end 53b, wherein the pin is adapted to fit within a channel positioned longitudinally in the side portions 22d, 22f of the bottom member 22. In these embodiments, when the protective housing 20 is opened, the pin in the other end 53b of the bracing member 53 slides along the channel until the desired angle A is reached, at which point the channel ends so that the pin abuts against that end of the channel. In yet other embodiments, the bracing members 53 may have an entirely different structure and location. For example, in the embodiment of the present invention illustrated in FIG. 3, bracing members 153 are positioned on the top joining portion 121a and the bottom joining portion 122a of the protective housing 120. When the protective housing 120 is opened to the desired angle (not shown), the interior surfaces 153a of the bracing members 153 abut against one another so that the top member 121 maintains the desired position relative to the bottom member 122. In yet other embodiments, the bracing members 53, 153 may provide for an adjustable angle between the top member 21, 121 and the bottom member 22, 122. For example, the bracing members 53 may have a structure so that they can hold the top member 21 relative to the bottom member 22 at angles of 60 degrees, 90 degrees, and 120 degrees. The bracing members 53, 153 may be constructed of any suitable rigid material that is strong enough to maintain the desired angle between the top member 21, 121 and the bottom member 22, 122 during the anticipated uses of the appliance 10, 110. For example, the bracing members 53, 153 may be constructed of metals, wood, ceramics, and rigid polymers (such as polyvinyl chloride) or combinations of any such materials.

In the embodiment of the appliance 10 illustrated in FIG. 1 and FIG. 2, the reflective backdrop 30 is further comprised of a top portion 31, a bottom portion 32, and an arcuate portion 33 disposed between the bottom portion 32 and the top portion 31. The bottom portion 32 of the reflective backdrop 30 is positioned approximately adjacent to the bottom member 22 of the protective housing 20, while the top portion 31 of the reflective backdrop 30 is positioned approximately adjacent to the top member 21 of the protective housing 20. The arcuate portion 33 of the reflective backdrop 30 is positioned approximately adjacent to the housing connecting means, which is the hinge 40 in this embodiment. It is to be noted that “approximately adjacent” in this context does not mean that the arcuate portion 33 rests against the surface of the hinge 40, the bottom joining portion 22a, or the top joining portion 21a. Instead, the arcuate portion 33 has a curved surface that is positioned away from these portions of the protective housing 20. The curved surface of the arcuate portion 33 permits a photograph of the object 11 to be made so that the object 11 will appear in the photograph without the appearance of a background. In other words, in the resulting photograph of the object 11 taken by the camera 12 while the object 11 is positioned on the appliance 10, the background of the photograph is essentially blank (except for a homogeneous color or combination of colors) so that there are no discernable features in the photograph of the object 11 other than the object 11 itself. As illustrated in FIG. 3, when the protective housing 120 is placed in the closed position, the reflective backdrop 130 is folded approximately in half, so that the top portion 131 of the reflective backdrop 130 remains approximately adjacent to the top member 121 and the bottom portion 132 of the reflective backdrop 130 remains approximately adjacent to the bottom member 122 of the protective housing 120. In the closed position, however, the arcuate portion 133 of the reflective backdrop 130 maintains a curved shape. It does not form a crease while the appliance 110 is in the closed position because a crease in the arcuate portion 133 of the reflective backdrop 130 would hinder the ability of the appliance 110 to produce photographs without the appearance of a background. In order to accomplish this ability to fold the reflective backdrop 130 without forming a crease, the reflective backdrop 130 is attached to the protective housing 120 by backdrop attachment means. In this embodiment, the backdrop attachment means is an adhesive 160 disposed between the top member 121 and the end of the top portion 131 of the reflective backdrop 130 that is distal from the arcuate portion 133 of the reflective backdrop 130, and an adhesive 160 disposed between the bottom member 122 and the end of the bottom portion 132 of the reflective backdrop 130 that is distal from the arcuate portion 133 of the reflective backdrop 130. In other embodiments, the backdrop attachment means may be any other suitable means or combination of means to permanently or removably attach the reflective backdrop 130 to the protective housing 120. For example, for permanent attachment of the reflective backdrop 130 to the protective housing 120, the backdrop attachment means may be comprised of adhesives, glues, adhesive tapes, epoxies, rivets, screws, pins, bolts, stitching, or any combination of any such means. For removable attachment of the reflective backdrop 130 to the protective housing 120, the backdrop attachment means may be comprised of zippers, hook and loop fasteners (such as VELCRO), clamps, or any combination of any such means.

In any case, the backdrop attachment means is disposed at the ends of the reflective backdrop 130 distal from the arcuate portion 133 thereof, and in some embodiments, on a portion of the top portion 131 and bottom portion 132 of the reflective backdrop 130, in a manner so that the arcuate portion 132 and remaining portions of the reflective backdrop 130 that are not attached to the protective housing 120 are free to move relative to the protective housing 120. In addition, the reflective backdrop 130 is generally adapted to be of a shape and size so that the portions of the reflective backdrop 130 distal from the arcuate portion 133 may be attached by the backdrop attachment means to the portions of the protective housing 120 that are distal from the housing connecting means (the hinge 140 in this embodiment). Further, the reflective backdrop 130 is of a size and shape that permits the arcuate portion 133 of the reflective backdrop 130 to retain a curved surface when the protective housing 120 is closed, but still allows the arcuate portion 133 to maintain a curved shape and the bottom portion 132 of the reflective backdrop 130 to rest against the bottom member 122 of the protective housing 120 when the protective housing 120 is open. Referring again to FIG. 1 and FIG. 2, this permits the object 11 (as depicted in FIG. 1 and FIG. 2) to be placed on the surface of the bottom portion 32 of the reflective backdrop 30 in a manner so that the object 11 is supported by the bottom portion 32 and the bottom member 22, while the arcuate portion 33 still retains a curved shape adequate for photographing the object 11 without the appearance of a background. For example, in the embodiment of the appliance 10 illustrated in FIG. 1 and FIG. 2, the reflective backdrop 30 is approximately the same shape as the protective housing 20, as it would be viewed from above the protective housing 20 with an angle A between the top member 21 and the bottom member 22 of 180 degrees. The reflective backdrop 30 has a width slightly less than that of the protective housing 20 in the illustrated embodiment. In other embodiments, the protective housing 20 may have a width significantly greater than the width of the reflective backdrop 30. In yet other embodiments, the reflective backdrop 30 and the protective housing 20 may not have the same general shape so that the distance between the side portions 21d, 21e, 21f, 22d, 22e, 22f of the protective housing 20 and the edges of the reflective backdrop 30 may not be uniform. For example, in other embodiments, the reflective backdrop 30 may be approximately elliptical in shape and may be positioned so that its ends, as positioned along its major radius, are attached to the protective housing 20 approximately adjacent to side portions 22e and 21e. It is to be noted that in various embodiments of the present invention, the reflective backdrop 30 may be of almost any shape, as long as it is suitable for photographing the object 11 without the appearance of a background, and any shape of reflective backdrop 30 may be combined with a protective housing 20 of any other suitable shape. In the illustrated embodiment, the length of the reflective backdrop 30 is less than the length of the protective housing 20, as measured between the side portion 22e of the bottom member 22 and side portion 21e of the top member 21 with an angle A between the top member 21 and the bottom member 22 of 180 degrees. The length of the reflective backdrop 30 is such that the arcuate portion 33 retains a curved shape when the protective housing 20 is closed, but when the protective housing 20 is open the bottom portion 32 of the reflective backdrop 30 rests against the surface of the bottom member 22 and the arcuate portion 33 retains a degree of curvature that allows for photographing the object 11 without the appearance of a background.

Referring to FIG. 4, which is an enlarged cross-sectional view of the thickness of the reflective backdrop 30 of the appliance 10 described above and illustrated in connection with FIG. 1 and FIG. 2, the reflective backdrop 230 is comprised of a support medium 235 and a reflective layer 236 disposed on the surface of the supporting medium 235. The support medium 235 may be constructed of any suitable semi-flexible material that allows the reflective backdrop 230 to flex in the manner described above and illustrated in connection with the appliance 10, 110 of FIG. 1 through FIG. 3, but still have enough resiliency to maintain the curved shape of the arcuate portion 33, 133 when the protective housing 20, 120 is placed in the closed position. For example, the support medium 235 may be comprised of paper, cloth, fabric, metal alloys, silicone, or a semi-flexible polymer material, such as poly carbonate, polystyrene, vinyl or any combination of any such materials. The reflective layer 236 may generally be comprised of any type of material that is currently known in the art or that may be developed in the art in the future that prevents the appearance of a background when the object 11 is photographed using the appliance 10, 110 as illustrated in FIG. 1 through FIG. 3. For example, the reflective layer 236 may be comprised of a retroreflective material, such as a retroreflective coating, paint, ink, or film, or any combination of such materials. These materials typically produce their retroreflective character by incorporating glass beads for spherical reflection, micro-prisms for cube corner reflection, or another similar lens for retroreflection. These materials also preferably have a retroreflectivity that meets or exceeds EN 471 Class 2 standards. More preferably, the reflective coating is a retroreflective transfer film comprised of retroreflective lenses bonded to a heat activated vinyl adhesive that is adhered to the surface of the support medium 235 as a laminate. An example of this type of transfer film is 3M SCOTCHLITE-8730 SILVER TRANSFER FILM. In other embodiments, the reflective layer 236 may be comprised of a material that provides uniform diffuse reflection of incident light. Examples of this type of material include white and natural muslin and combinations of such materials. In yet other embodiments, the reflective character of the reflective backdrop 30, 130 may be created by the presence of retroreflective or diffuse-reflective material present within the support medium 235, as opposed to a reflective layer 236 on the surface of the support medium 235. This may be the case, for example, where the support medium 235 is comprised of two transparent layers of material having a reflective layer 236 laminated between them or where the support medium 235 has retroreflective or diffuse-reflective material incorporated within it. Referring again to FIG. 1 and FIG. 2, it is to be noted that in various embodiments of the present invention, the reflective surface (for example, the surface of the reflective layer 236 illustrated in FIG. 4) of the reflective backdrop 30 may be of almost any color, depending upon the nature of the object 11 being photographed, the desired background color and characteristics, and the individual preferences of the user of the appliance 10. In addition, the reflective backdrop 30 may be of more than one color or may be of different shades of the same color, or any combination thereof, in various embodiments. In still other embodiments, the appliance 10 may comprise more than one reflective backdrop 30, wherein each of the reflective backdrops 30 have a different color or different shade of the same color. For example, in some embodiments of the appliance 10 of FIG. 1 and FIG. 2, the reflective backdrop 30 may be replaced with two reflective backdrops 30, wherein one reflective backdrop 30 is silver and is half the size of the illustrated reflective backdrop 30, and another reflective backdrop 30 is blue and is half the size of the illustrated reflective backdrop 30, so that the blue and silver reflective backdrops 30 are placed side-by-side. In these embodiments, the user of the appliance 10 may readily choose from two colors of background that may be used in photographing the object 11. In embodiments where the reflective backdrop 30 is removably attached to the protective housing 20 by the backdrop attachment means, the user of the appliance 10 may remove a reflective backdrop 30 of one color or shade and replace it with a reflective backdrop 30 of a different color or shade. In still other embodiments, the appliance 10 may comprise more than one reflective backdrop 30, wherein the reflective backdrops 30 are layered in a manner so that they may be stored within the protective housing 20 when not in use. For example, referring to the appliance 10 of FIG. 1 and FIG. 2, two reflective backdrops 30 may be placed within the protective housing 20 one on top of another, where one reflective backdrop 30 is placed adjacent to and permanently attached to the protective housing 20, and the other reflective backdrop 30 is placed over the first reflective backdrop 30 and is removably attached to either the protective housing 20 or the first reflective backdrop 30. In these embodiments, if the user of the appliance 10 desires a different color or shade of reflective backdrop 30, the top reflective backdrop 30 may be removed so that the other reflective backdrop 30 may be used. In other embodiments, all of such reflective backdrops 30 may be removably attached to the protective housing 20.

Referring to the appliance 10 of FIG. 1 and FIG. 2 as an example, the present invention also includes a method of photographing an object 11 so that the object 11 appears in the photograph without the appearance of a background. In one embodiment, the method comprises the following steps. First, an appliance 10 is provided to assist in photographing the object 11, wherein the appliance 10 may have any of the structures, features, characteristics and operation of any embodiments or combinations of embodiments of the present invention illustrated and described above in connection with FIG. 1 through FIG. 4. Second, the top member 21 and the bottom member 22 are positioned so that the protective housing 20 is in the “open” position, wherein the reflective backdrop 30 is positioned so that it is available as a background for photographing the object 11. Third, the object 11 is placed on the reflective backdrop 30 in the position desired by the user of the appliance 10 for purposes of photographing the object 11. Fourth, a photographic device, such as a camera 12, is provided for purposes of photographing the object 11. Fifth, the photographic device (camera 12) is positioned in a location so that the object 11 and a portion of the reflective backdrop 30 form the field of view of the photographic device (camera 12). Sixth, the object 11 is photographed using the photographic device (camera 12). In other embodiments of the present invention, the method of using the appliance 10 may further comprise the steps of removing the object 11 from the reflective backdrop 30 and positioning the top member 21 and the bottom member 22 in the “closed” position (wherein the top member 21 and the bottom member 22 are positioned approximately adjacent to one another). In yet other embodiments wherein the backdrop attachment means provides for removable attachment of the reflective backdrop 30 to the protective housing 20, the method of using the appliance 10 may further comprise the steps of removing the reflective backdrop 30 from the protective housing 20 and attaching the same or a different reflective backdrop 30 to the protective housing 20 using the backdrop attachment means. In these embodiments, such steps may be performed after the second step, but before the third step, of the method described above in this paragraph.

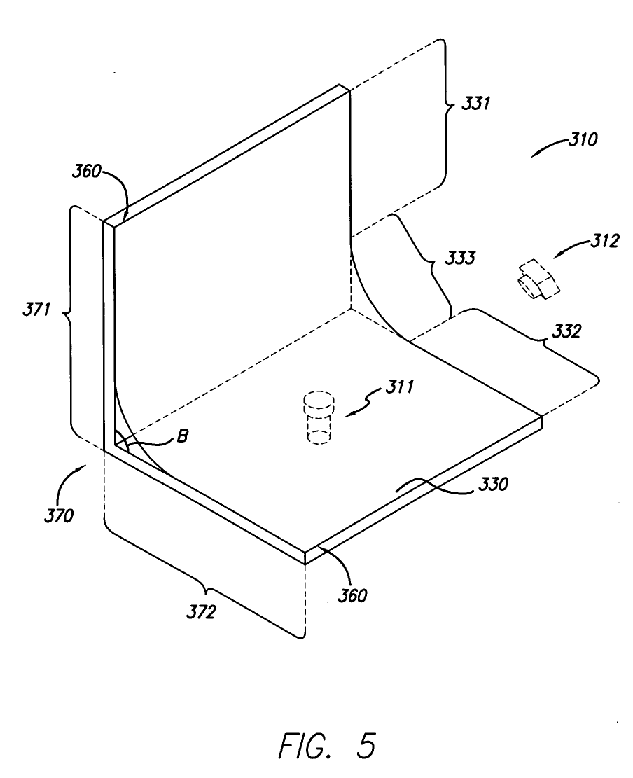

In yet other embodiments of the present invention, as illustrated in FIG. 5, an appliance 310 for assisting in the photography of an object 311 is disclosed that is not necessarily portable. In the illustrated embodiment, the appliance 310 is comprised of a supporting member 370, a retroreflective backdrop 330, and backdrop attachment means for attaching the retroreflective backdrop 330 to the supporting member 370, as described in more detail below. In these embodiments, the retroreflective backdrop 330 provides a means for photographing the object 311 without the appearance of a background in the resulting photograph of the object 311. In some embodiments, as illustrated in FIG. 5, the supporting member 370 is further comprised of a top supporting portion 371 and a bottom supporting portion 372. In the illustrated embodiment, the angle B between the top supporting portion 371 and the bottom supporting portion 372 is approximately 90 degrees. In other embodiments, the angle B may be almost any angle or combination of angles desired in order to photograph the object 311, as described in more detail herein. Preferably, the angle B between the top supporting portion 371 and the bottom supporting portion 372 is in the range between approximately 45 degrees and approximately 180 degrees. More preferably, the angle B between the top supporting portion 371 and the bottom supporting portion 372 is in the range of 90 degrees to 180 degrees. In addition, as illustrated in FIG. 5, the preferred shape of the supporting member 370 is square or rectangular. The supporting member 370 may, however, be of almost any other shape in other embodiments. For example, the supporting member 370, or the top supporting portion 371 or the bottom supporting portion 372, or both, may have the approximate shape of a circle, ellipse, trapezoid, triangle, parallelogram, polygon, or other shape having curved or line segments or any combination of any such shapes. In the illustrated embodiment, the top supporting portion 371 and the bottom supporting portion 372 of the supporting member 370 are comprised of approximately flat plates. In other embodiments, the supporting member 370, or the top supporting portion 371 or the bottom supporting portion 372, or both, may have almost any type of framework that is adequate to support the retroreflective backdrop 330 in the manner required or desired to photograph the object 311. For example, in other embodiments, the supporting member 370 may be comprised of tubular members that generally follow the perimeter edges of the supporting member 370 illustrated in FIG. 5. The supporting member 370 may be constructed from almost any suitable rigid or semi-rigid material or combinations of such materials that are capable of supporting the retroreflective backdrop 330 in the manner described herein. For example, the supporting member 370 may be constructed of wood, metal, leather, rigid paper products, and rigid polymer materials, such as polyvinyl chloride or polystyrene, or any combination of all such materials. Preferably, the supporting member 370 is constructed of a rigid polymer material, such as polyvinyl chloride. It is to be noted that in some embodiments, the supporting member 370 may generally follow the contour of the surface of an arcuate portion 333 of the retroreflective backdrop 330, rather than forming an approximately right angle, as illustrated in FIG. 5. It is also to be noted that the supporting member 370 need not be of the same size or shape as the reflective backdrop 330. For example, in some embodiments, the supporting member 370 may be a wall upon which the retroreflective backdrop 330 is mounted using the backdrop attachment means, which are described in more detail below. As another example, the supporting member 370 may be a floor or other surface upon which the retroreflective backdrop 330 is laid.

In the embodiment of the present invention illustrated in FIG. 5, the retroreflective backdrop 330 is further comprised of a top portion 331, a bottom portion 332, and an arcuate portion 333 disposed between the bottom portion 332 and the top portion 331. In this embodiment, a portion of the bottom portion 332 of the retroreflective backdrop 330 is positioned approximately adjacent to a portion of the bottom supporting portion 372 of the supporting member 370, a portion of the top portion 331 of the retroreflective backdrop 330 is positioned approximately adjacent to a portion of the top supporting portion 371 of the supporting member 370, and the arcuate portion 333 of the retroreflective backdrop 330 has an arcuate shape. Generally, the retroreflective backdrop 330 of these embodiments of the present invention may have substantially the same structure, features, characteristics and operation, or any combination of the same, as the reflective backdrops 30, 130, 230 described above and illustrated in connection with FIG. 1 through FIG. 4, except that the retroreflective backdrop 330 of these embodiments of the present invention are constructed of a retroreflective material and not a diffuse-reflective material. In addition, the backdrop attachment means of these embodiments of the present invention may have substantially the same structure, features, characteristics and operation, or any combination of the same, as the backdrop attachment means described above and illustrated in connection with FIG. 1 through FIG. 4, except that the backdrop attachment means of these embodiments of the present invention are used to attach the retroreflective backdrop 330 to the supporting member 370. In the illustrated embodiment, the backdrop attachment means is comprised of an adhesive 360 disposed between a portion of the surfaces of the top supporting portion 371 and the top portion 331 of the retroreflective backdrop 330 and a portion of the surfaces of the bottom supporting portion 372 and the bottom portion 332 of the retroreflective backdrop 330.

The present invention also includes a method of photographing an object 311 using the various embodiments of the appliance 310 described above and illustrated in connection with FIG. 5, so that the object 311 appears in the resulting photograph of the object 311 without a background. The method comprises the steps of providing the appliance 310 to assist in photographing the object 311, positioning the object 311 on or in front of the reflective backdrop 330, providing a photographic device (such as a camera 312) to photograph the object 311, positioning the photographic device (camera 312) in a location so that the object 311 and a portion of the retroreflective backdrop 330 form the field of view of the photographic device (camera 312), and photographing the object 311 using the photographic device (camera 312).

What is claimed is:

1. A portable appliance for assisting in the photography of an object, the appliance comprising:
(a) a protective housing, which is further comprised of a top member, a bottom member, and housing connecting means for pivotally connecting the top member to the bottom member;
(b) a reflective backdrop; and
(c) backdrop attachment means for attaching the reflective backdrop to the protective housing;
(d) wherein the reflective backdrop provides a means for photographing the object without the appearance of a background in the photograph of the object.

2. The appliance of claim 1, wherein:
(a) the reflective backdrop is further comprised of a bottom portion, a top portion, and an arcuate portion disposed between the bottom portion and the top portion; and
(b) the bottom portion of the reflective backdrop is positioned approximately adjacent to the bottom member, the top portion of the reflective backdrop is positioned approximately adjacent to the top member, and the arcuate portion of the reflective backdrop is positioned approximately adjacent to the housing connecting means.

3. The appliance of claim 2, wherein the bottom member and the top member of the protective housing are positioned approximately adjacent to one another so that the protective housing is in a “closed” position, and the arcuate portion of the reflective backdrop retains its curved shape while the protective housing is in the closed position.

4. The appliance of claim 2, wherein the reflective backdrop has approximately the same shape as the protective housing.

5. A portable appliance for assisting in the photography of an object, the appliance comprising:
(a) a protective housing, which is further comprised of:
(i) a top member, which is further comprised of a top joining portion and a lid portion;
(ii) a bottom member, which is further comprised of a bottom joining portion and a base portion; and
(iii) housing connecting means for pivotally connecting the top joining portion of the top member to the bottom joining portion of the bottom member;
(b) a reflective backdrop; and
(c) backdrop attachment means for attaching the reflective backdrop to the protective housing;
(d) wherein the reflective backdrop provides a means for photographing the object without the appearance of a background in the photograph of the object.

6. The appliance of claim 5, wherein:
(a) the reflective backdrop is further comprised of a bottom portion, a top portion, and an arcuate portion disposed between the bottom portion and the top portion;
(b) the bottom portion of the reflective backdrop is positioned approximately adjacent to the bottom member, the top portion of the reflective backdrop is positioned approximately adjacent to the top member, and the arcuate portion of the reflective backdrop is positioned approximately adjacent to the housing connecting means;
(c) the end of the top portion of the reflective backdrop that is distal from the arcuate portion is attached approximately to the end of the lid portion of the top member that is distal from the top joining portion by the backdrop attachment means; and
(d) the end of the bottom portion of the reflective backdrop that is distal from the arcuate portion is attached approximately to the end of the base portion of the top member that is distal from the bottom joining portion by the backdrop attachment means.

7. The appliance of claim 6, wherein the arcuate portion of the reflective backdrop retains its curved shape while the base portion of the bottom member and the lid portion of the top member of the protective housing are positioned approximately adjacent to one another so that the protective housing is in a “closed” position.

8. The appliance of claim 6, wherein the backdrop attachment means is comprised of a means to removably attach the reflective backdrop to the protective housing.

9. The appliance of claim 8, wherein the backdrop attachment means is comprised of hook and loop fasteners, clamps or any combination of such fasters and clamps.

10. The appliance of claim 6, wherein the backdrop attachment means is comprised of a means to permanently attach the reflective backdrop to the protective housing.

11. The appliance of claim 10, wherein the backdrop attachment means is comprised of an adhesive.

12. The appliance of claim 6, wherein the bottom portion, the top portion, and the arcuate portion of the reflective backdrop are each comprised of a support medium and a reflective layer disposed on the surface of the support medium.

13. The appliance of claim 12, wherein the support medium is comprised of a semi-flexible material.

14. The appliance of claim 13, wherein the support medium is comprised of polycarbonate.

15. The appliance of claim 12, wherein the reflective layer is comprised of a retroreflective material.

16. The appliance of claim 15, wherein the reflective layer is white, silver, or black in color.

17. The appliance of claim 5, wherein the protective housing is approximately rectangular or square in shape.

18. The appliance of claim 17, wherein the protective housing has a length in the range between approximately 3 feet and 1.5 feet and a width in the range between approximately 2 feet and 1.2 feet.

19. The appliance of claim 18, wherein the protective housing has a thickness in the range of from one inch to six inches.

20. The appliance of claim 5, wherein the protective housing is further comprised of at least one bracing member, wherein one end of the at least one bracing member is pivotally attached to the top member, and the other end of the at least one bracing member is pivotally attached to the bottom member.

21. The appliance of claim 20, wherein the protective housing is in an approximately “open” position when the appliance is positioned for photographing the object, and the at least one bracing member positions the angle between the top member and the bottom member while the protective housing is in the open position to an angle in the range from 90 degrees to 180 degrees.

22. A portable appliance for assisting in the photography of an object, the appliance comprising:
(a) a protective housing, which is further comprised of a top member, a bottom member, and housing connecting means for pivotally connecting the top member to the bottom member;
(b) a reflective backdrop, wherein the reflective backdrop serves as the background for purposes of photographing the object; and
(c) backdrop attachment means for attaching the reflective backdrop to the protective housing;
(d) wherein:
(i) the reflective backdrop is further comprised of a bottom portion, a top portion, and an arcuate portion disposed between the bottom portion and the top portion;
(ii) the bottom portion of the reflective backdrop is positioned approximately adjacent to the bottom member, the top portion of the reflective backdrop is positioned approximately adjacent to the top member, and the arcuate portion of the reflective backdrop is positioned approximately adjacent to the housing connecting means; and
(iii) the protective housing is in a “closed” position when the bottom member and the top member of the protective housing are positioned approximately adjacent to one another, and the arcuate portion of the reflective backdrop retains its curved shape while the protective housing is in the closed position.

23. The appliance of claim 22, wherein the housing connecting means is comprised of a hinge.

24. The appliance of claim 22, wherein the protective housing is further comprised of closure means for holding the top member adjacent to the bottom member when the protective housing is in the closed position.

25. The appliance of claim 22, wherein the protective housing is further comprised of at least one handle and handle attachment means for operably attaching the at least one handle to the top member or the bottom member of the protective housing.

26. The appliance of claim 22, wherein the reflective backdrop does not have the same approximate shape as the protective housing.

27. A portable appliance for assisting in the photography of an object, the appliance comprising:
(a) a protective housing, which is further comprised of:
(i) a top member, which is further comprised of a top joining portion and a lid portion;
(ii) a bottom member, which is further comprised of a bottom joining portion and a base portion; and
(iii) housing connecting means for pivotally connecting the top joining portion of the top member to the bottom joining portion of the bottom member;
(b) at least two reflective backdrops, wherein each of the at least two reflective backdrops is further comprised of a bottom portion, a top portion, and an arcuate portion disposed between the bottom portion and the top portion, and wherein the reflective backdrop is disposed within the perimeter of the protective housing; and
(c) backdrop attachment means for attaching the at least two reflective backdrops to the protective housing or to another of the at least two reflective backdrops;
(d) wherein the at least two reflective backdrops provide a means for photographing the object without the appearance of a background in the photograph of the object, and the arcuate portion of the at least two reflective backdrops retain their curved shape while the base portion of the bottom member and the lid portion of the top member of the protective housing are positioned approximately adjacent to one another so that the protective housing is in a “closed” position.

28. The appliance of claim 27, wherein:
(a) the bottom portion of the first of the at least two reflective backdrops is positioned approximately adjacent to the bottom member, the top portion of the first of the at least two reflective backdrops is positioned approximately adjacent to the top member, and the arcuate portion of the first of the at least two reflective backdrops is positioned approximately adjacent to the housing connecting means; and
(b) the bottom portion of each additional at least two reflective backdrops is positioned approximately adjacent to the bottom portion of the prior at least two reflective backdrops, the top portion of each additional at least two reflective backdrops is positioned approximately adjacent to the top portion of the prior at least two reflective backdrops, and the arcuate portion of each additional at least two reflective backdrops is positioned approximately adjacent to the arcuate portion of the prior at least two reflective backdrops.

29. The appliance of claim 27, wherein:
(a) the bottom portion of the at least two reflective backdrops is positioned approximately adjacent to a portion of the bottom member, the top portion of the at least two reflective backdrops is positioned approximately adjacent to a portion of the top member, and the arcuate portion of the at least two reflective backdrops is positioned approximately adjacent to a portion of the housing connecting means; and
(b) the at least two reflective backdrops are positioned in the protective housing in a side-by-side manner.

30. A method of photographing an object so that the object appears in the photograph without a background, the method comprising the steps of:
(a) providing a portable appliance to assist in photographing the object, wherein the appliance is comprised of:
(i) a protective housing, which is further comprised of a top member, a bottom member, and housing connecting means for pivotally connecting the top member to the bottom member;
(ii) a reflective backdrop; and
(iii) backdrop attachment means for attaching the reflective backdrop to the protective housing;
(iv) wherein the reflective backdrop provides a means for photographing the object without the appearance of a background in the photograph of the object;
(b) positioning the top member and the bottom member so that the protective housing is in an “open” position, wherein the reflective backdrop is positioned so that it is available as a background for photographing the object;
(c) positioning the object on or in front of the reflective backdrop;
(d) providing a photographic device to photograph the object and positioning the photographic device in a location so that the object and a portion of the reflective backdrop form the field of view of the photographic device; and
(e) photographing the object using the photographic device.

31. The method of claim 30, further comprising the steps of:
(a) removing the object from the reflective backdrop; and
(b) positioning the top member and the bottom member in a “closed” position, wherein the top member and the bottom member are positioned approximately adjacent to one another.

32. The method of claim 30, further comprising the steps of:
(a) removing the reflective backdrop from the protective housing, wherein the backdrop attachment means provides for removable attachment of the reflective backdrop to the protective housing; and
(b) attaching the same or a different reflective backdrop to the top member and the bottom member using the backdrop attachment means;
(c) wherein such steps are performed after step (b), but before step (c), of claim 30.

33. An appliance for assisting in the photography of an object, the appliance comprising:
(a) a supporting member;
(b) a retroreflective backdrop; and
(c) backdrop attachment means for attaching the reflective backdrop to the supporting member;
(d) wherein the retroreflective backdrop provides a means for photographing the object without the appearance of a background in the photograph of the object.

34. The appliance of claim 33, wherein:
(a) the supporting member is further comprised of a top supporting portion and a bottom supporting portion;
(b) the retroreflective backdrop is further comprised of a bottom portion, a top portion, and an arcuate portion disposed between the bottom portion and the top portion; and
(c) all or a portion of the bottom portion of the retroreflective backdrop is positioned approximately adjacent to all or a portion of the bottom supporting portion of the supporting member, all or a portion of the top portion of the retroreflective backdrop is positioned approximately adjacent to all or a portion of the top supporting portion of the supporting member, and the arcuate portion of the retroreflective backdrop has an arcuate shape.

35. The appliance of claim 34, wherein the backdrop attachment means is comprised of an adhesive.

36. The appliance of claim 33, wherein the bottom portion, the top portion, and the arcuate portion of the retroreflective backdrop are each comprised of a support medium and a retroreflective layer disposed on the surface of the support medium.

37. The appliance of claim 35, wherein the support medium is comprised of polycarbonate.

38. The appliance of claim 35, wherein the retroreflective layer is white, silver, or black in color.

39. A method of photographing an object using the appliance of claim 33 so that the object appears in the photograph without a background, the method comprising the steps of:
(a) providing the appliance to assist in photographing the object;
(b) positioning the object on or in front of the retroreflective backdrop;
(c) providing a photographic device to photograph the object;
(d) positioning the photographic device in a location so that the object and a portion of the retroreflective backdrop form the field of view of the photographic device; and
(e) photographing the object using the photographic device.
